(19) United States
(12) Patent Application Publication
(10) Pub. No.: US 2026/0331829 A1
(43) Pub. Date: Oct. 22, 2026

(54) CONNECTOR

(71) Applicants: Nippon Tanshi Co., Ltd., Hiratsuka-shi, Kanagawa (JP); HONDA MOTOR CO., LTD., Tokyo (JP)

(72) Inventors: Yutaka TANABE, Kanagawa (JP); Motohiro TAKAHASHI, Tokyo (JP); Masaaki SAKANO, Tokyo (JP)

(21) Appl. No.: 19/115,621

(22) PCT Filed: Apr. 20, 2013
(86) PCT No.: PCT/JP2023/015812

§ 371 Date: Mar. 26, 2025

(30) Foreign Application Priority Data
Sep. 27, 2022 (JP) 2022-153615

(51) Int. Cl. H01R 13/629; H01M 8/0247

(52) U.S. Cl. CPC H01R 13/62955; H01M 8/0247; H01R 13/62938; H01M 2250/20; H01R 2201/26

(57) ABSTRACT

A connector that can be attached to and detached from a fuel cell, wherein the fuel cell includes multiple plates arranged at intervals in a predetermined stacking direction and each having a receiving recess, each of the receiving recesses of the plates is provided with a locking part, the connector includes a housing that can be inserted into the receiving recesses of the multiple plates, terminal members held by the housing and electrically connected to the plates when the housing is inserted into the receiving recesses, a lever that can be inserted into the housing, and a lock member which, in response to a pressing force due to insertion of the lever, rotates about an axis extending in the stacking direction and engages with the locking part.

### CROSS-REFERENCE TO RELATED APPLICATIONS

This application is the U.S. National Stage entry of International Application No. PCT/JP2023/015812, filed on Apr. 20, 2023, which, in turn, claims priority to JP Patent Application No. 2022-153615, filed on Sep. 27, 2022, both of which are hereby incorporated herein by reference in their entireties for all purposes.

### TECHNICAL FIELD

The present invention relates to a connector having multiple terminals accommodated in a housing, and particularly relates to an electric connector that can be connected to a fuel cell.

### BACKGROUND ART

In recent years, efforts to realize a low-carbon society or a carbon-free society are becoming more active, and in relation to vehicles, electrification of vehicles is promoted for the purpose of reducing CO2 emission and improving energy efficiency. In an electrified vehicle, namely, an electric vehicle, a motor for generating a driving force and an electric cell for supplying electric power to the motor are installed.

As electric cells to be installed in electric vehicles, fuel cells are attracting attention (for example, Patent Document 1). A fuel cell has multiple cells stacked in a predetermined direction (hereinafter, the first direction). Each cell includes an air electrode and a fuel electrode, a polymer electrolyte membrane disposed between the air electrode and the fuel electrode, and separators disposed on outer sides of the air electrode and the fuel electrode.

The fuel cell of Patent Document 1 is provided with a cell-monitoring connector for checking the voltage of each cell. The separators of the fuel cell are provided with receiving recesses, and the receiving recesses define a receiving space for receiving the cell-monitoring connector in the fuel cell.

The cell-monitoring connector includes a housing and connection terminals. The housing is inserted into the receiving space along a second direction which intersects the first direction. When the housing is inserted into the receiving space, the connection terminals are connected to the separators, whereby the checking of the voltage of each cell becomes possible.

To prevent the cell-monitoring connector from coming out of the fuel cell, each separator is provided with locking parts. The locking parts are located around the receiving recess and have a hook shape. The cell-monitoring connector includes levers provided in the housing and lever operators for operating the levers.

In connection with the movement of the lever operators in a third direction that intersects the first direction and the second direction, each lever is displaced between a first position in which the lever protrudes from the outer surface of the housing in the third direction and a second position in which the lever does not protrude. By causing the levers to protrude and retreat according to the movement of the lever operators, it is possible to hook the levers on the locking parts of the separators. When the levers are hooked on the locking parts, the cell-monitoring connector is prevented from coming off from the fuel cell.

### PRIOR ART DOCUMENT(S)

### Patent Document(s)

Patent Document 1: JP2021-77616A

### SUMMARY OF THE INVENTION

### Task to Be Accomplished by the Invention

In the fuel cell, stacking misalignment may occur when manufactured or when in use. Therefore, development of an electric connector provided with a lock mechanism having a large engagement margin so as to be capable of locking even when stacking misalignment of the separators occurs is desired.

In the cell-monitoring connector of Patent Document 1, in response to the movement of the lever operators in the third direction, the housing undergoes deflection deformation, and each lever is displaced between the first position and the second position. Therefore, there is a problem that it is difficult to ensure the amount of protrusion of the levers (lock members) from the housing, and it is difficult for the levers to be locked to the locking parts.

The present invention has been made in view of such problems of the conventional technology, and a primary object thereof is to provide a connector that is engageable with a locking part provided in a fuel cell, wherein the connector is easily locked to the locking part.

### Means to Accomplish the Task

A first aspect of the present invention provides a connector (1) that can be attached to and detached from a fuel cell (3), wherein the fuel cell is provided with multiple plates (9) arranged at intervals in a predetermined stacking direction and each having a receiving recess (11), each of the receiving recesses of the plates is provided with a locking part (21), and the connector comprises: a housing (25) that can be inserted into the receiving recesses of the multiple plates; terminal members (27) held by the housing and electrically connected to the plates when the housing is inserted into the receiving recesses; a lever (31) that can be inserted into the housing; and a lock member (29) which, with a pressing force due to insertion of the lever, rotates about an axis extending in the stacking direction and engages with the locking part.

According to this, with the pressing force due to insertion of the lever, the lock member rotates and engages with the locking part. Therefore, compared to the case where the lock member engages with the locking part by undergoing deflection deformation, the connector is more easily locked to the locking part.

In a second aspect of the present invention, the lock member is provided with a locked part (77) that can be locked to the locking part, and due to insertion of the lever into the housing, the lock member is displaced from a retracted position in which the locked part is retracted into an inside of the housing to a protruding position in which the locked part protrudes to an outside of the housing.

According to this, since the locked part is exposed from the housing in the protruding position, the locked part easily engages with the locking part.

In a third aspect of the present invention, the locking part includes a cutout (23) provided in the plate, and the locked part includes a hook part (85) configured to be inserted into each of the cutouts provided in the multiple plates that are adjacent to each other and to be hooked on the plates and at least one insertion wall (87) configured to be inserted between the plates.

According to this, since the locked part can be locked to multiple plates, the connector can be locked to the fuel cell more firmly compared to the case where the locked part is locked to a single plate. Also, since the insertion wall is inserted between the plates when the locked part is locked to the locking part, deformation of the plates can be prevented.

In a fourth aspect of the present invention, the insertion wall is inserted between each pair of adjacent plates of the multiple plates on which the hook part is hooked.

According to this, since the insertion wall is inserted between each pair of adjacent plates, electrical contact of the adjacent plates can be prevented.

In a fifth aspect of the present invention, the lock member is provided with a pair of shaft parts (79) extending along a direction of the axis, the housing is provided with bearing parts (81) for rotatably receiving the shaft parts of the lock member and includes a lock member receiving part (61) for receiving the lock member, and the lock member rotates due to insertion of the lever into the lock member receiving part.

According to this, the lock member can be rotatably supported in the housing, and it is possible to rotate the lock member by inserting the lever into the lock member receiving chamber.

In a sixth aspect of the present invention, an insertion direction of the lever into the housing is the same as an insertion direction into the receiving recess.

According to this, it is possible to lock the lock member to the locking part by moving the lever in the insertion direction of the housing. Therefore, compared to the case where the lever is moved in a direction perpendicular to the insertion direction, the space in the direction perpendicular to the insertion direction required for the operation of the lever can be reduced.

In a seventh aspect of the present invention, the lever and the lock member are provided with a first cam mechanism (101) for converting a movement of the lever in an insertion direction to a rotation of the lock member.

According to this, the lock member can be rotated by insertion of the lever into the housing.

In an eighth aspect of the present invention, the lever and the housing are provided with a restriction mechanism (103) for restricting a rotation of the lock member by restricting a movement of the lever in a direction opposite to an insertion direction when the lock member comes to the protruding position.

According to this, when the lock member comes to the protruding position, the rotation of the lock member is restricted by the restriction mechanism. Thereby, the lock member is maintained in the protruding state, and thus, the connector can be prevented from coming off from the fuel cell.

In a ninth aspect of the present invention, the lever includes a pull-out part (107) for pulling out from the housing in the direction opposite to the insertion direction against restriction by the restriction mechanism, and a second cam mechanism (109) for rotating the lock member from the protruding position to the retracted position according to the movement of the lever in the direction opposite to the insertion direction is provided between the lever and the lock member.

According to this, by pulling out the lever by using a tool, the lock member is moved to the retracted position, whereby the engagement between the lock member and the locking part is released so that the connector can be separated from the fuel cell.

In a tenth aspect of the present invention, the lock member is provided in each of both end portions in a direction perpendicular to an insertion direction of the housing and perpendicular to the stacking direction.

According to this aspect, compared to the case where the lock member is provided in one end portion of the housing, the connector can be joined to the fuel cell more firmly.

### Effect of the Invention

As described above, according to the present invention, it is possible to provide a connector that is engageable with a locking part provided in a fuel cell, wherein the connector is easily locked to the locking part.

### BRIEF DESCRIPTION OF THE DRAWINGS

FIG. 1 A perspective view showing a state of a connector before being locked to a fuel cell by lock members

FIG. 2 A vertical cross-sectional perspective view of a fuel cell and a connector connected to the fuel cell and an enlarged view of a part surrounded by a two-dot chain line

FIG. 3 An exploded perspective view of the connector excluding a retainer and terminal members and an enlarged view of a part surrounded by a two-dot chain line

FIG. 4 A perspective view of a terminal member

FIG. 5 Perspective views of a lock member (A) as seen from a side away from the housing main body and (B) as seen from a side of the housing main body

FIG. 6 A cross-sectional view taken along line VI-VI of FIG. 5(A)

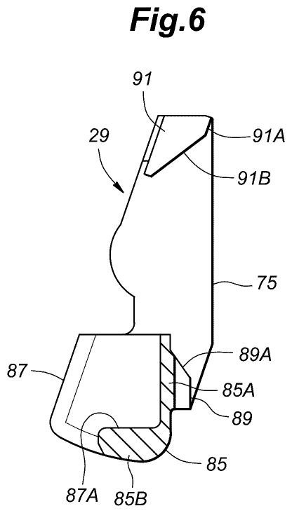

FIG. 7 A perspective view of a lever

FIG. 8 Side views of the connector (A) when the lock member is in a retracted position and (B) when the lock member is in a protruding position

FIG. 9 Lateral cross-sectional views for explaining changes of the positions of the lever and the lock member as the lock member is displaced from (A) the retracted position to (E) the protruding position due to insertion of the lever

FIG. 10 A front-rear cross-sectional view for explaining the position of the lever when the lock member is in (A) the retracted position and (B) the protruding position

FIG. 11 (A) A lateral side view showing the positional relationship between the lever and a tool when the lever is pulled out by using the tool and (B) a cross-sectional view taken along line XIB-XIB

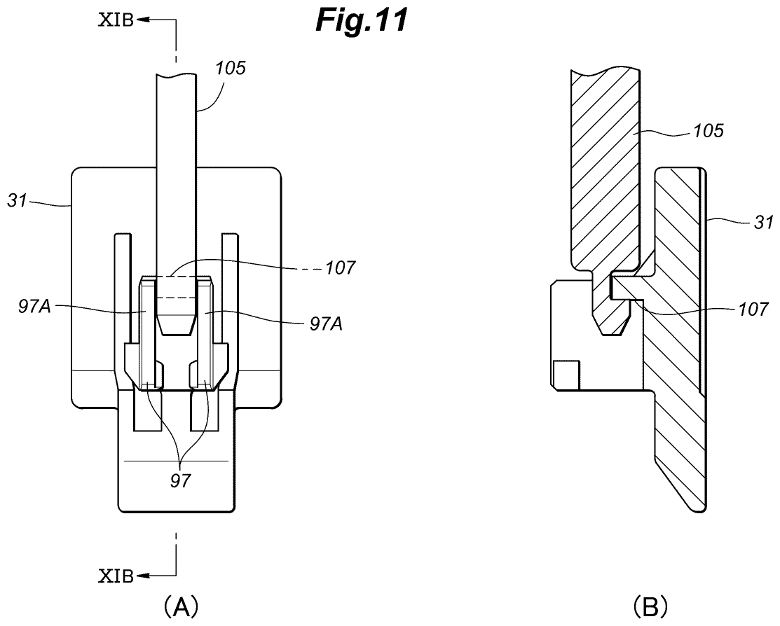

FIG. 12 Lateral cross-sectional views for explaining changes of the positions of the lever and the lock member as the lock member is displaced from (A) the protruding position to (E) the retracted position when the lever is pulled out with a tool

FIG. 13 (A) a perspective view showing a first modification of the connector and (B) a perspective view showing a second modification of the connector

FIG. 14 (A) A perspective view showing a third modification of the connector and (B) a lateral cross-sectional view showing the connector when connected to the fuel cell

### MODE(S) FOR CARRYING OUT THE INVENTION

In the following, a connector according to an embodiment of the present invention will be described with reference to the drawings.

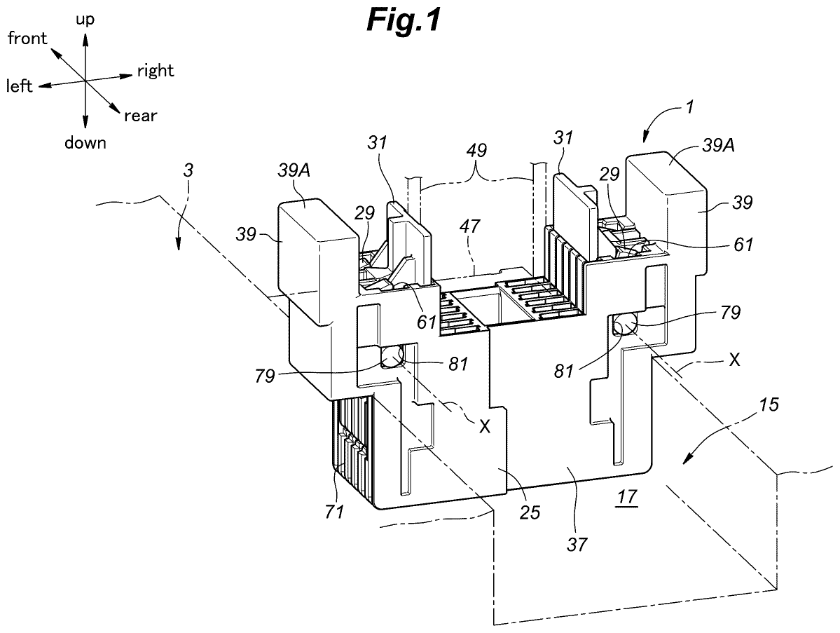

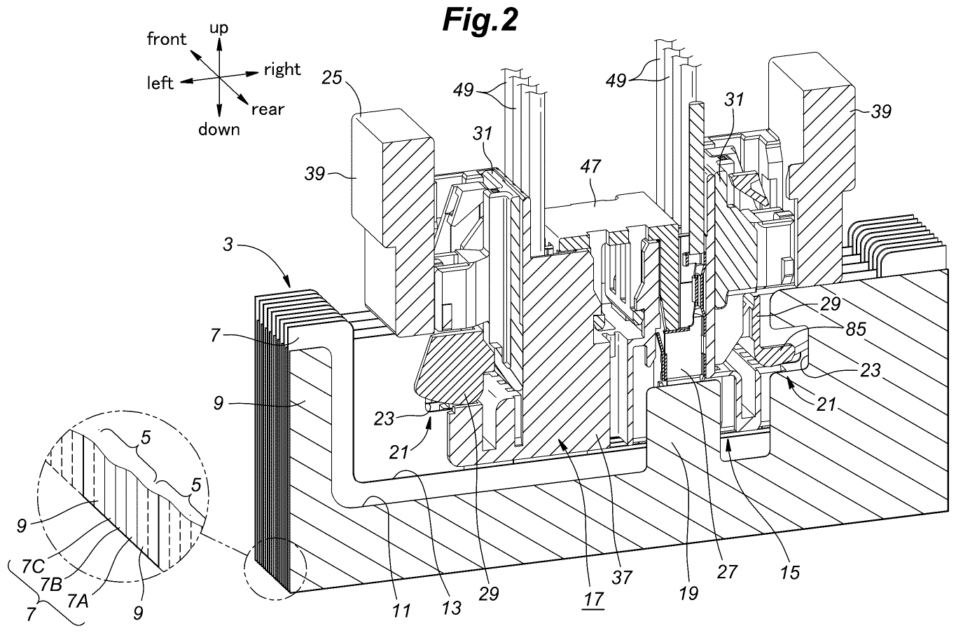

As shown in FIG. 1, a connector 1 according to the present invention is attached to a fuel cell 3. As shown in FIG. 2, the fuel cell 3 to which the connector 1 is attached has multiple cells 5 stacked in a predetermined direction (hereinafter, the stacking direction). In the present embodiment, the fuel cell 3 is mounted on a vehicle such that the stacking direction is in a horizontal direction. The connector 1 is used as an electric connector for monitoring the voltage of each of the cells 5 of the fuel cell 3.

In the following, for convenience of explanation, description will be made based on a state in which the connector 1 is connected and locked to the fuel cell 3, with the stacking direction of the cells 5 being defined as the front-rear direction, a direction that is horizontal and perpendicular to the stacking direction being defined as the left-right direction, and the vertical direction being defined as the up-down direction. Note, however, that these directions are for convenience of explanation, and the posture and arrangement of the fuel cell 3 of the present invention are not limited by these directions. Also, the present invention is not limited by the use or type of the fuel cell 3.

The fuel cell 3 is a polymer electrolyte fuel cell and, as shown in an enlarged view of FIG. 2, is provided with membrane-electrode assemblies 7 (MEAs), and plates 9 (also called the separators or separator plates).

Each membrane-electrode assembly 7 includes an air electrode 7A and a fuel electrode 7B serving as electrodes and a polymer electrolyte membrane 7C disposed between the air electrode 7A and the fuel electrode 7B. The polymer electrolyte membrane 7C is a film having an insulating property and is composed of an ion exchange membrane which allows hydrogen ions generated at the fuel electrode 7B to move to the air electrode 7A. Each of the air electrode 7A and the fuel electrode 7B has a reaction catalyst applied thereto, and the air electrode 7A functions as a positive electrode (cathode) and the fuel electrode 7B functions as a negative electrode (anode).

The plates 9 are provided on outer sides of each membrane-electrode assembly 7, namely, on outer sides of the air electrode 7A and the fuel electrode 7B which oppose each other via the polymer electrolyte membrane 7C. Thereby, the plates 9 are arranged at intervals in the stacking direction. Each plate 9 is composed of a thin plate made of metal such as stainless steel (SUS), titanium, etc. Each plate 9 is provided with flow paths for passing hydrogen or oxygen (air). Each of the air electrode 7A and the fuel electrode 7B is in electrical contact with the plate 9 on the outer side thereof. Therefore, each plate 9 is at the same electric potential as that of the air electrode 7A or the fuel electrode 7B that is in electrical contact with it.

The plates 9 are respectively formed with receiving recesses 11 which are recessed inward at positions overlapping in the front-rear direction (the stacking direction). Specifically, each plate 9 has a plate shape, and the receiving recess 11 is provided on the upper edge of the plate 9 such that the receiving recess 11 is formed to be recessed downward. The membrane-electrode assemblies 7 are also formed with assembly recesses 13 overlapping with the receiving recesses 11 in the stacking direction. The receiving recesses 11 of the multiple plates 9 and the assembly recesses 13 of the membrane-electrode assembly 7 form a receiving groove 15 that extends in the front-rear direction. The receiving groove 15 defines a receiving space 17 into which the connector 1 is removably inserted.

In the present embodiment, the odd number-th plates 9 counted from the rear end of the fuel cell 3 have the same shape, and the even number-th plates 9 also have the same shape. The shape of the receiving recesses 11 of the odd number-th plates 9 and the shape of the receiving recesses 11 of the even number-th plates 9 are bilaterally symmetric to each other, and thus, in the following, the receiving recesses 11 of either the odd number-th plates 9 or the even number-th plates 9 will be described in detail.

Each receiving recess 11 is recessed downward at the upper edge of the plate 9 in a quadrilateral shape. The lower edge of the receiving recess 11 is provided with a terminal part 19 that extends out upward. Also, the receiving recess 11 of the plate 9 is provided with a locking part 21. In the present embodiment, the locking part 21 defines an edge part of the receiving recess 11 on left or right side. The locking part 21 includes a cutout 23 that is recessed laterally outward from a part of the receiving recess 11 above an approximate center with respect to the up-down direction.

Next, the structure of the connector 1 will be described with reference to the drawings.

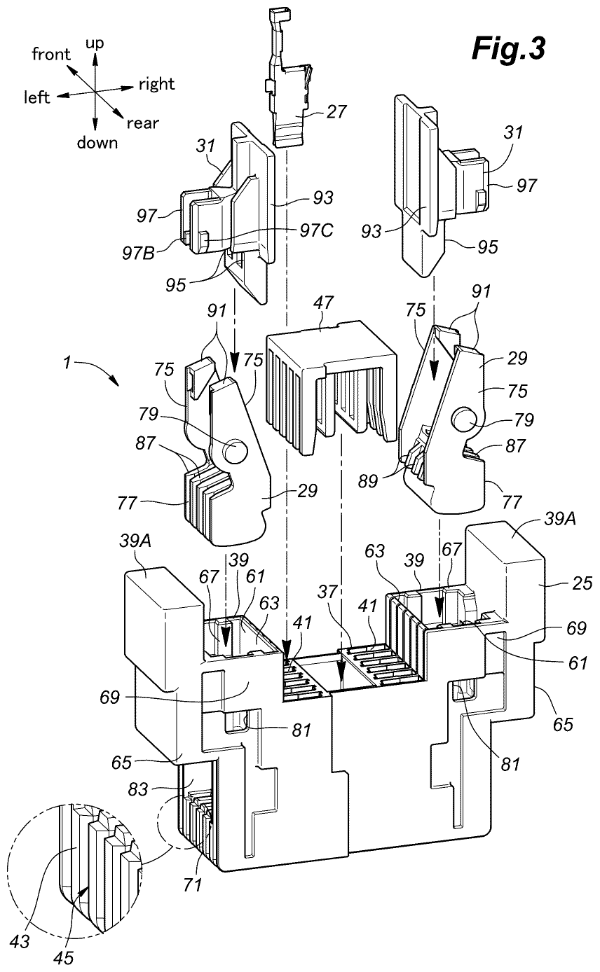

As shown in FIG. 3, the connector 1 includes a housing 25, terminal members 27 (see FIG. 2), lock members 29, and levers 31.

The housing 25 is a member made of resin and is configured such that at least a part thereof can be removably inserted into the receiving space 17 from above. The housing 25 includes a housing main body 37 constituting the central part thereof and having a substantially rectangular parallelepiped shape and housing side portions 39 provided on both the left and right sides of the housing main body 37.

The housing main body 37 is provided with multiple terminal holes 41 extending in the up-down direction. In the present embodiment, in the housing main body 37, pairs of terminal holes 41 disposed on the left and right are arranged in the front-rear direction.

The terminal members 27 are each composed of a member made of metal. The terminal members 27 are respectively inserted into the terminal holes 41 and are held in the housing main body 37. In the present embodiment, a retainer 47 made of resin (see FIG. 2) is inserted into the housing main body 37 from the rear, whereby detachment of the terminal members 27 from the housing main body 37 is prevented.

The terminal members 27 are respectively connected to wires 49. When the connector 1 is inserted into the receiving space 17, the terminal members 27 respectively contact the terminal parts 19 of the plates 9. The voltage generated by each cell 5 can be acquired by measuring the electric potential difference between the wires 49 of the associated terminal members 27.

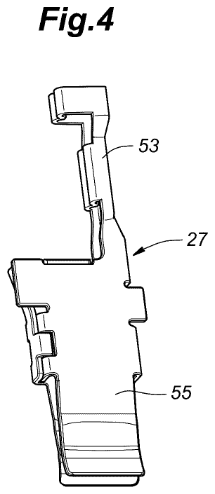

In the present embodiment, as shown in FIG. 4, each terminal member 27 is formed by bending a metal member. The terminal member 27 includes a crimp part 53 to which the wire 49 (see FIG. 2) is crimped and a contact part 55 configured to contact the terminal part 19. When a core wire of the wire 49 is crimped to the crimp part 53, the wire 49 and the terminal member 27 are electrically connected. The contact part 55 is configured by a pair of metal plates having mutually facing surfaces. When the connector 1 is inserted into the receiving space 17, the terminal part 19 is inserted between the metal plates configuring the contact part 55, and the metal plates contact the terminal part 19, whereby the terminal member 27 is electrically connected to the plate 9.

As shown in FIG. 3, each of the housing side portions 39 is formed with a lock member receiving part 61 that is recessed downward from the upper end thereof. The lock member receiving part 61 is a recess in a quadrangular prism shape and extends downward. A boundary of the lock member receiving part 61 on the side close to the housing main body 37 in the left-right direction is defined by an inner wall 63. A boundary of the lock member receiving part 61 on the side away from the housing main body 37 in the left-right direction is defined by an outer wall 65. A front boundary of the lock member receiving part 61 is defined by a front wall 67, a rear boundary of the lock member receiving part 61 is defined by a rear wall 69, and a lower boundary of the lock member receiving part 61 is defined by a lower wall 71.

In the present embodiment, the housing side portions 39 are respectively provided on the left and right side portions of the housing main body 37. Each of the housing side portions 39 protrudes more upward (in the direction opposite to the insertion direction) than the housing main body 37. On left and right edges of the upper surfaces of the housing side portions 39, protection walls 39A which protrude upward (in the direction opposite to the insertion direction) are provided.

As shown in an enlarged view of FIG. 3, a laterally outer surface (a side surface away from the housing main body 37) of the lower wall 71 is provided with plate-shaped separation walls 43 which protrude laterally outward and extend in the up-down direction. Due to the provision of the separation walls 43, the laterally outer surface of the lower wall 71 is formed with separation grooves 45 that extend in the up-down direction between the separation walls 43. When the housing 25 is inserted into the receiving space 17, the housing main body 37 is received in the receiving space 17, and the plates 9 are respectively received in the separation grooves 45. Thereby, the separation walls 43 are inserted between adjacent ones of the plates 9.

The lock members 29 are members made of resin. In the present embodiment, as shown in FIG. 1, the lock members 29 are respectively provided at both left and right ends of the housing 25, namely, at both end portions in a direction perpendicular to the downward direction, which is the insertion direction of the connector 1, and perpendicular to the stacking direction of the cells 5 (the front-rear direction).

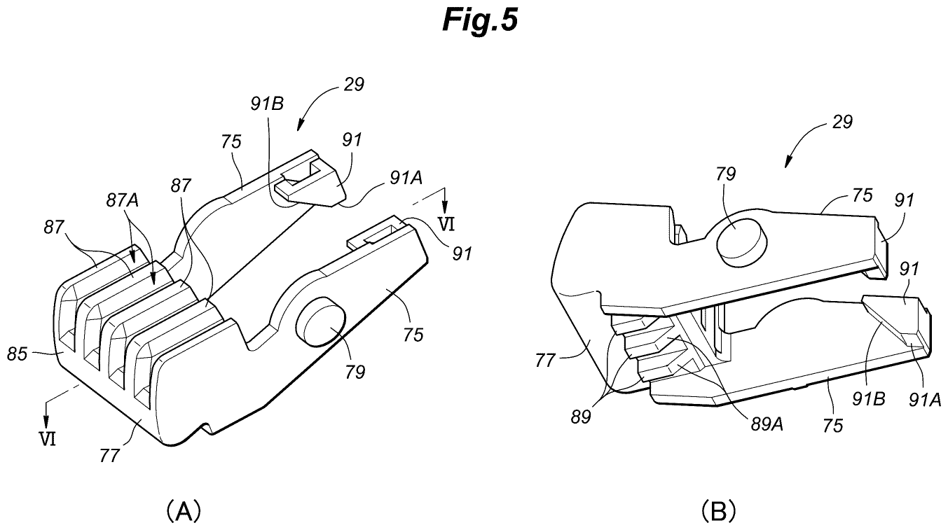

As shown in FIG. 5, each lock member 29 includes a pair of front and rear arm parts 75 and an arm connection part 77 extending in the front-rear direction to connect the lower ends of the arm parts 75.

Each of the arm parts 75 has surfaces facing in the front-rear direction and is in a plate shape extending in the up-down direction. At the center of each of the arm parts 75 in the up-down direction, a shaft part 79 having a cylindrical columnar shape is provided. The shaft parts 79 each having a cylindrical columnar shape protrude in mutually opposite directions. The front wall 67 and the rear wall 69 of each housing side portion 39 are respectively provided with bearing parts 81 for receiving the shaft parts 79. In the present embodiment, the bearing parts 81 are formed as through holes respectively penetrating the front wall 67 and the rear wall 69 at positions aligned in the front-rear direction.

As shown in FIG. 1, the lock members 29 are received in the lock member receiving parts 61, with the shaft parts 79 of the arm parts 75 being respectively born by the bearing parts 81. Thereby, each lock member 29 is supported by the housing 25 to be rotatable (free to rotate) about an axis X extending in the front-rear direction (the stacking direction).

As shown in FIG. 3, at a lower edge of each outer wall 65, a through hole 83 penetrating therethrough in the left-right direction is provided. By rotating about the axis X, each lock member 29 is displaceable between a retracted position in which the arm part 75 is received in the lock member receiving part 61 and the arm connection part 77 is retracted into the inside of the housing 25 and a protruding position in which a part of the arm connection part 77 passes the through hole 83 of the outer wall 65 to reach the outside of the lock member receiving part 61 and protrudes to the outside of the housing 25.

The arm connection part 77 includes a connection part main body 85 connecting the lower ends of the arm parts 75, multiple insertion walls 87 (see FIG. 5(A)) provided on a side of the connection part main body 85 opposite from the housing main body 37, and multiple ridges 89 (see FIG. 5(B)) provided on a surface of the connection part main body 85 on the side of the housing main body 37. In addition, as shown in FIG. 5(A) and 5(B), upper ends of the arm parts 75 are provided with protrusions 91 that protrude toward each other.

The connection part main body 85 is provided with a vertical wall 85A extending in the up-down direction and having surfaces facing in the left-right direction and a horizontal wall 85B extending from the lower end of the vertical wall 85A in a direction away from the housing main body 37, so that the connection part main body 85 has an L-shaped lateral cross-section.

Each of the insertion walls 87 is in a plate shape having surfaces facing in the front-rear direction. Each insertion wall 87 is connected to a surface of the vertical wall 85A on the side away from the housing main body 37 and an upper surface of the horizontal wall 85B. As shown in FIG. 5(A), the insertion walls 87 are arranged to be spaced from each other. Due to the provision of the insertion walls 87, the arm connection part 77 is formed with arm receiving grooves 87A which are recessed toward the housing main body 37 between the insertion walls 87.

As shown in FIG. 5(B), the ridges 89 protrude from the surface of the connection part main body 85 on the side of the housing main body 37 and form stripes extending in the up-down direction. The ridges 89 are arranged at intervals on the surface of the vertical wall 85A on the side of the housing main body 37.

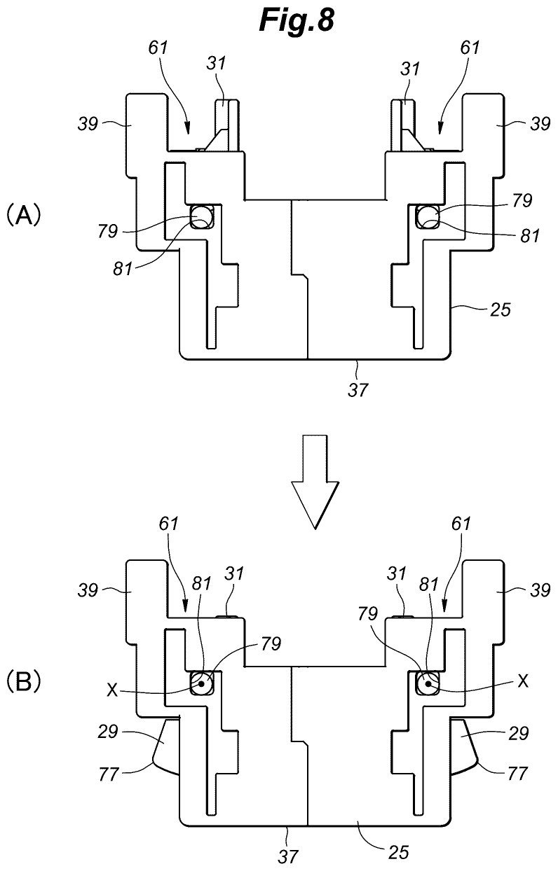

The levers 31 are members made of resin and, as shown in FIG. 1 and FIG. 8(A), are configured to be capable of being respectively inserted into the left and right lock member receiving parts 61 from above. In this way, since the levers 31 are configured to be capable of being inserted into the corresponding lock member receiving parts 61 in which the lock members 29 are received, it is possible to convert the pressing force due to the insertion of the lever 31 or the pull-out force and to rotate the lock members 29.

In the present embodiment, each lever 31 includes a lever main body 93 having surfaces facing in the left-right direction, a pair of rail parts 95 joined to the surface of the lever main body 93 facing away from the housing main body 37 and extending in the up-down direction, and a Y-shaped part 97 that protrudes in a bifurcated manner from between the rail parts 95 in the direction away from the housing main body 37. The Y-shaped part 97 is provided with plate parts 97A which are disposed to oppose each other in the front-rear direction at the tips. In the present embodiment, the Y-shaped part 97 is positioned between the two rail parts 95 which are positioned one behind the other.

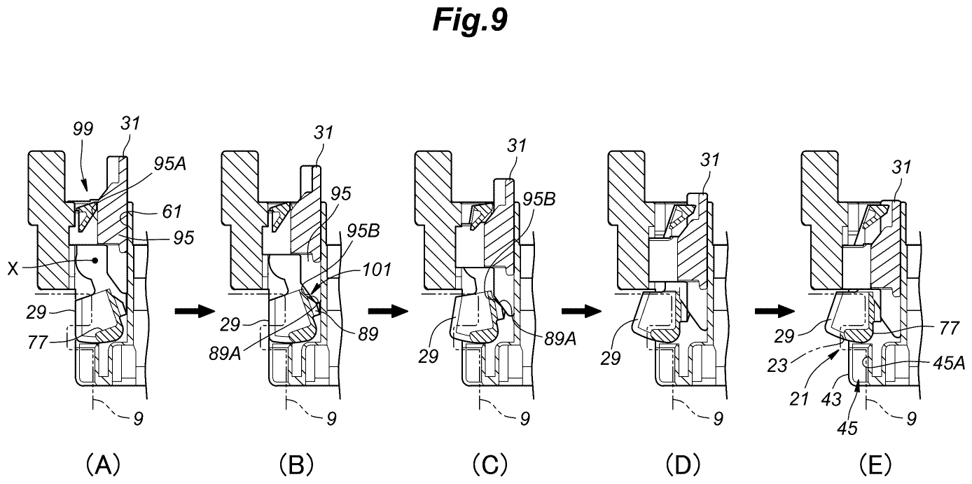

As shown in FIG. 8(A) and FIG. 9(A), the lock member 29 and the lever 31 are provided with a holding mechanism 99 for holding the lock member 29 in the retracted position. Due to the holding mechanism 99, it is possible to maintain the lock member 29 in the retracted position by inserting only a part of the lever 31 into the lock member receiving part 61.

In the present embodiment, the holding mechanism 99 includes lever retaining surfaces 95A provided on protruding end surfaces of the rail parts 95 provided on the lever 31 and lock retaining surfaces 91A provided on the protrusions 91 at the upper ends of the arm parts 75 of the lock member 29.

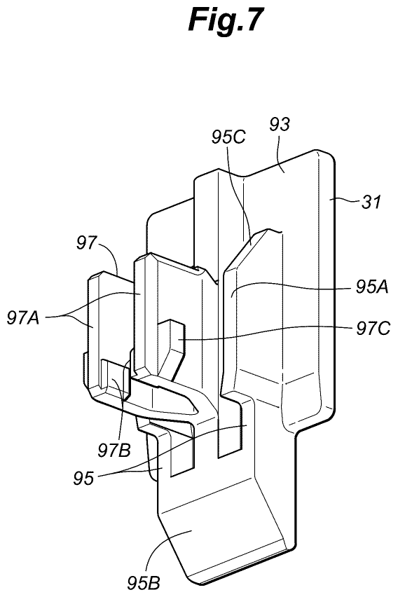

As shown in FIG. 7, the lever retaining surfaces 95A are composed of flat surfaces facing in the lateral direction away from the housing main body 37. As shown in FIG. 5(A) and 5(B), the lock retaining surfaces 91A are composed of flat surfaces facing in the lateral direction toward the housing main body 37. As shown in FIG. 9(A), when the lock member 29 is in the retracted position, the upper end of the lever 31 is at a position protruding from the lock member receiving part 61, and the lever retaining surfaces 95A contact the lock retaining surfaces 91A so that the rotation of the lock member 29 is restricted. Thereby, the lock member 29 is held in the retracted position.

The lock member 29 and the lever 31 are provided with a first cam mechanism 101 that, with the pressing force due to insertion of the lever 31, rotates the lock member 29 that is in the retracted position and thereby moves the lock member 29 to the protruding position. Thus, as shown in FIG. 8(B) and FIG. 9(B) to 9(E), when the lever 31 is inserted, with the housing main body 37 having been inserted in the receiving recesses 11, the movement of the lever 31 is converted to a rotation of the lock member 29 about the axis X, and the lock member 29 in the retracted position moves to the protruding position. At this time, the arm connection part 77 protrudes into the cutouts 23 and engages with the locking parts 21. Thereby, upward movement of the arm connection part 77 is restricted and detachment of the connector 1 from the fuel cell 3 is prevented.

In the present embodiment, the first cam mechanism 101 is configured by first arm inclined surfaces 89A provided on the ridges 89 of the arm connection part 77 and a first rail inclined surface 95B provided at the lower end of the rail parts 95. As shown in FIG. 5, the first arm inclined surfaces 89A are inclined in a direction so as to approach the housing main body 37 as they extend downward. The first rail inclined surface 95B is inclined in a direction so as to approach the housing main body 37 as it extends downward. In the present embodiment, the lower end portions of the two rail parts 95 are connected in the front-rear direction to be integral, and the first rail inclined surface 95B is formed on that integral part.

As shown in FIG. 9(A) to 9(E), if the user inserts the lever 31 into the lock member receiving part 61 from above when the lock member 29 is in the retracted position, the first rail inclined surface 95B comes into contact with the first arm inclined surfaces 89A. When the user presses the lever 31 downward, due to the pressing force caused thereby, the first arm inclined surfaces 89A are pushed by the first rail inclined surface 95B in the direction away from the housing main body 37. Accordingly, the lock member 29 rotates about the axis X to move to the protruding position.

As shown in FIG. 9(E), when the lock member 29 is in the protruding position, the lock member 29 is locked to the locking parts 21 provided in the multiple plates 9. In the present embodiment, the lock member 29 is locked to the locking parts 21 due to insertion of the connection part main body 85 of the lock member 29 into the cutouts 23 of the locking parts 21. At this time, the insertion walls 87 are respectively inserted between adjacent ones of the plates 9.

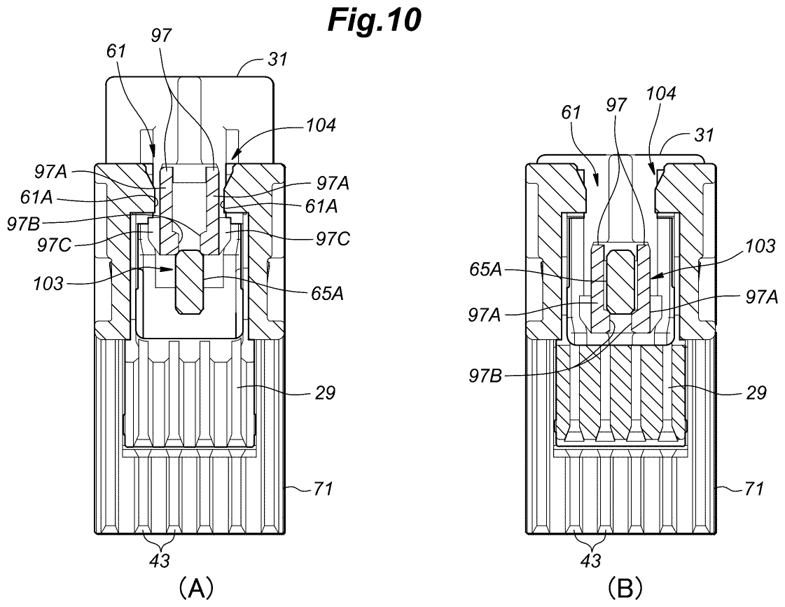

The lever 31 and the housing 25 are provided with a restriction mechanism 103 for restricting the movement of the lever 31 in the direction opposite to the insertion direction (see FIG. 10(A) and 10(B)). With the restriction mechanism 103, the rotation of the lock member 29 is restricted and the lock member 29 is maintained in the protruding position.

In the present embodiment, as shown in FIG. 10(A) and 10(B), the restriction mechanism 103 includes a protruding part 65A provided on the outer wall 65 defining the lock member receiving part 61 and locking claws 97B provided on the respective tips of the Y-shaped part 97.

The protruding part 65A protrudes toward the lock member receiving part 61 at a position above the through hole 83 of the outer wall 65. The protruding part 65A has a quadrangular prism shape with a quadrilateral lateral cross-sectional shape. The locking claws 97B are respectively provided on the lower portions of the plate parts 97A and protrude toward each other.

When the user pushes the lever 31 downward, as shown in FIG. 10(A), the protruding part 65A is inserted between the two plate parts 97A constituting the tips of the Y-shaped part 97. At this time, the locking claws 97B slidably contact the front and rear side surfaces of the protruding part 65A, respectively, and the Y-shaped part 97 elastically deforms such that the plate parts 97A move away from each other.

When the lock member 29 is put in the protruding position due to the downward movement of the lever 31, as shown in FIG. 10(B), the locking claws 97B move to the lower side of the protruding part 65A and the Y-shaped part 97 returns to the original shape. As a result, the upward movement of the locking claws 97B is restricted by the protruding part 65A, whereby the movement of the lever 31 in the upward direction (namely, the direction opposite to the insertion direction) is restricted and the lock member 29 is maintained in the protruding position. Accordingly, the engagement between the connector 1 and the fuel cell 3 is maintained and the connector 1 can be prevented from coming off from the fuel cell 3.

Preferably, as shown in FIG. 10(A), the connector 1 is provided with a detachment preventing mechanism 104 for preventing detachment of the lever 31 from the housing 25. In the present embodiment, the detachment preventing mechanism 104 includes detachment preventing claws 97C provided on the Y-shaped part 97 and detachment preventing protrusions 61A provided on the opening edge (upper edge) of the lock member receiving part 61. The detachment preventing claws 97C are respectively provided on the surfaces of the plate part 97A facing away from each other, and the detachment preventing claws 97C protrude in directions away from each other. The detachment preventing protrusions 61A are positioned above the detachment preventing claws 97C of the lever 31 in the retracted position and each protrude toward the inside of the lock member receiving part 61. Thereby, upward movement of the detachment preventing claws 97C is restricted by the detachment preventing protrusions 61A and detachment of the lever 31 from the housing 25 is prevented.

Besides, to facilitate the insertion of the lever 31 into the lock member receiving part 61, each detachment preventing claw 97C may be preferably provided with a slope inclined in the direction away from the plate part 97A toward the top, or each detachment preventing protrusion 61 A may be preferably provided with a slope inclined downward toward the inside of the lock member receiving part 61.

As shown in FIG. 1, the lock members 29 are provided at both left and right ends of the housing 25, respectively. Therefore, compared to the case where the lock member 29 is provided in one end portion of the housing 25, namely, at only one of the left end and the right end of the housing 25, the connector 1 can be joined to the fuel cell 3 more firmly.

The lever 31 includes a pull-out part 107 configured to detachably engage with a tool 105 for pulling out the lever 31 from the housing 25 in the direction opposite to the insertion direction against the restriction by the restriction mechanism 103.

In the present embodiment, the pull-out part 107 is provided at a tip portion of the Y-shaped part 97. Specifically, the pull-out part 107 connects the rear edges of the plate parts 97A and is in a plate shape having surfaces facing in the up-down direction.

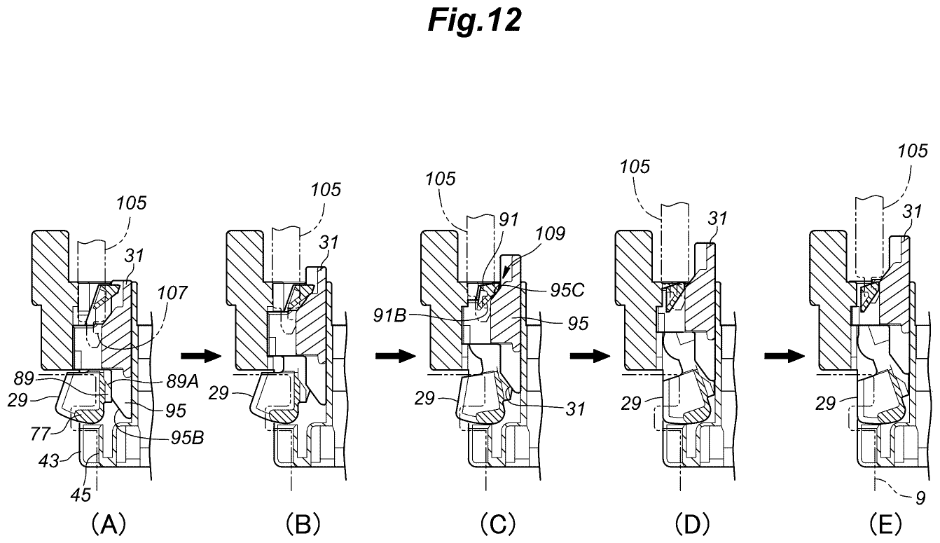

As shown in FIG. 12(A) to 12(E), when the user engages the tool 105 with the pull-out part 107 and pulls up the tool 105, the restriction by the restriction mechanism 103 is released and the lever 31 moves upward.

Between the lever 31 and the lock member 29, a second cam mechanism 109 for rotating the lock member 29 from the protruding position to the retracted position according to the movement of the lever 31 in the direction (upward direction) opposite to the insertion direction is provided. Thereby, the movement of the lever 31 in the direction (upward direction) opposite to the insertion direction is converted to the rotation of the lock member 29, so that the lock member 29 rotates from the protruding position to the retracted position.

In the present embodiment, the second cam mechanism 109 includes a second rail inclined surface 95C (see also FIG. 7) provided at the upper end of the rail part 95 of the lever 31 and a second arm inclined surface 91B (see FIG. 5(A) and 5(B)) provided on the protrusion 91 at the upper end of the arm part 75 of the lock member 29. The second rail inclined surface 95C is inclined in the direction toward the housing main body 37 toward the top when the lever 31 is inserted and the lock member 29 is in the protruding position. The second arm inclined surface 91B also is inclined in the direction toward the housing main body 37 toward the top.

When the user hooks the tool 105 onto the pull-out part 107 and pulls up the lever 31, the tips of the Y-shaped part 97 deform to open, and the locking claws 97B become movable along the front and rear side surfaces of the protruding part 65A, respectively, whereby the restriction by the restriction mechanism 103 is released.

Further, the second rail inclined surface 95C comes into contact with the second arm inclined surface 91B, and the upper end of the arm part 75 is pushed out in the direction away from the housing main body 37 along with the upward movement of the lever 31. As a result, the lock member 29 rotates about the axis X and is displaced from the protruding position to the retracted position. Thereby, the engagement of the lock member 29 with the locking parts 21 is released, and the connector 1 can be separated from the fuel cell 3.

Next, the effects of the connector 1 thus configured will be described.

In the fuel cell 3, there is a problem that stacking misalignment of the plates 9 may occur when manufactured or when in use, and the stacking misalignment may accumulate.

Therefore, in a case where each plate 9 is provided with the locking part 21 and a lock part for detachably engaging with the locking parts 21 is provided to prevent the connector 1 from coming off from the fuel cell 3, it is necessary to set the movable range of the lock part than usual and to ensure a sufficient engagement margin.

As a method for configuring the housing 25 to include the lock part for detachably engaging with the locking parts 21, it may be conceived, for example, to provide the housing 25 with an arm made of resin material to be capable of undergoing deflection deformation and provided with the lock part. In this case, the lock part detachably engages with the locking part 21 due to deflection deformation of the arm, but the arm part 75 cannot be deformed beyond the mechanical strength of the resin material. Therefore, the movable range of the lock part cannot be ensured, and the engagement margin between the locking part 21 and the lock part may be insufficient.

In contrast, in the present invention, the lock member 29 rotates due to insertion of the lever 31 into the lock member receiving part 61. Thereby, the lock member 29 is displaced from the retracted position to the protruding position, and the lock member 29 is locked to the locking part 21. In this way, the displacement of the lock member 29 is performed as the rotation of the lock member 29 and thus, compared to the case where deflection deformation or the like is used, the movable range of the lock member 29 becomes larger and it is easy to ensure the amount of protrusion of the lock member 29 from the housing 25. Therefore, the connector 1 can be easily locked to the locking parts 21. In this way, according to the present invention, even if there is a greater tolerance than usual in the stacking dimension, the connector 1 can be engaged with the fuel cell 3 more reliably, and the connector 1 can be prevented from coming off from the fuel cell 3 more reliably.

Therefore, since the connector 1 is prevented from coming off from the fuel cell 3, the voltage of the cells 5 can be favorably monitored. Accordingly, it becomes possible to favorably monitor the state of the fuel cell 3 mounted on the electric vehicle, for example. Thus, the connector 1 according to the present invention contributes to reduction of CO2 emission and improvement of energy efficiency.

When the lock member 29 is in the protruding position, the arm connection part 77 is exposed from the housing 25 and protrudes into the cutouts 23 of the plates 9. In this way, when in the protruding position, the arm connection part 77 is exposed from the housing 25, whereby the arm connection part 77 can be easily locked to the locking parts 21 (the cutouts 23).

Also, in the case where the lock part for detachably engaging with the locking parts 21 is configured by an arm that undergoes deflection deformation, the lock part slidably contacts the end portions of the plates 9 during insertion of the connector 1. Therefore, there is a risk that deformation of the plates 9 may occur. In contrast, in the present invention, when the connector 1 (the housing main body 37) is inserted into the receiving groove 15, the lock member 29 is held in the retracted position. Therefore, during insertion of the connector 1, the lock member 29 does not contact the plates 9, and thus, deformation of the plates 9 can be prevented more reliably.

The connector 1 is inserted into the receiving groove 15 downward from above Also, the lever 31 is inserted into the lock member receiving part 61 downward from above, whereby the lock member 29 is locked to the locking parts 21. Thus, the insertion direction of the connector 1 and the operation direction of the lever 31 are both downward and are the same.

On the other hand, in the case where the insertion direction of the connector 1 and the operation direction of the lever 31 are different, there is a risk that a load may be applied from the connector 1 to the plates 9 in a direction perpendicular to the surfaces due to operation of the lever 31. Therefore, the fuel cell 3 is required to have a strength that can withstand the load in the direction perpendicular to the surfaces that may be applied due to operation of the lever 31. In the present invention, since the insertion direction of the connector 1 and the operation direction of the lever 31 are the same, it is possible to suppress the load in the direction perpendicular to the surfaces that may be applied due to operation of the lever 31. Therefore, compared to the case where the insertion direction of the connector 1 and the operation direction of the lever 31 are different, the strength required of the fuel cell 3 in the direction perpendicular to the surfaces of the plates 9 can be suppressed.

In the present invention, the operation of the lever 31 can be performed from above the housing 25 (from the side opposite to the insertion direction). Namely, the insertion direction of the housing 25 into the receiving space 17 (the receiving recess 11) and the insertion direction of the lever 31 are the same. Therefore, compared to the case where the configuration is made such that the lever 31 is operated from one of the left and right sides with respect to the insertion direction of the connector 1, the space in the direction perpendicular to the insertion direction required for the operation of the lever 31 can be reduced. Therefore, the space around the connector 1 for operating the lock member 29 can be reduced.

Further, by configuring such that the operation of the lever 31 is performed from above the housing 25, it is possible to utilize the space necessary to route the wires 49. Thereby, the connector 1 can be made suitable for use where it is required to arrange the connectors 1 densely as in the fuel cell 3.

Due to the holding mechanism 99 for holding the lock member 29 in the retracted position, it is possible to hold the lock member 29 in the retracted position during insertion of the housing 25 into the receiving groove 15, and therefore, it is possible to prevent the lock member 29 from contacting the plate 9 during the insertion. Thus, a load is less likely to be applied on the plate 9 when the connector 1 is connected, whereby deformation of the plates 9 of the fuel cell 3 can be prevented and the plates 9 can be protected.

As shown in FIG. 12(A), in the present embodiment, even after the lock member 29 is put in the protruding position, the lever 31 can be inserted downward. Configuration is made such that when the lever 31 is fully inserted in the lock member receiving part 61, due to rotation of the lock member 29, the first arm inclined surfaces 89A do not engage (contact) with the first rail inclined surface 95B. Therefore, even if a load in a direction away from the receiving groove 15 (upward direction) is applied to the connector 1 when the lever 31 is fully inserted in the lock member receiving part 61, the first arm inclined surfaces 89A do not engage with the first rail inclined surface 95B, and the lever 31 does not go upward. Also, since the protruding end surfaces of the ridges 89 contact the protruding end surfaces of the rail parts 95 to restrict the rotation of the lock member 29, the engagement of the lock member 29 with the locking parts 21 is not released and the connector 1 is prevented from coming off from the fuel cell 3.

Also, when the lever 31 is pulled out upward with the tool 105, the lock member 29 moves to the retracted position, and the connector 1 becomes able to be separated from the fuel cell 3. Thus, even when the connector 1 is detached from the fuel cell 3, it is possible to prevent the lock member 29 from contacting the plates 9, whereby the plates 9 can be protected.

When the housing 25 is inserted into the receiving space 17, the plates 9 are received in the separation grooves 45, and the separation walls 43 are inserted between adjacent ones of the plates 9. Thereby, contact of adjacent ones of the plates 9 can be prevented, and further, deflection and deformation of the plates 9 can be prevented. Also, when the lock member 29 is in the protruding position, the plates 9 are received in the arm receiving grooves 87A, and the insertion walls 87 of the lock member 29 are inserted between the plates 9. Thereby, contact of adjacent ones of the plates 9 can be prevented.

The lock member 29 is displaced from the retracted position to the protruding position by rotation. Therefore, compared to the case where the lock part for detachably engaging with the locking parts 21 is configured by an arm that undergoes deflection deformation, the insertion walls 87 can be inserted between the plates 9 more deeply. Thus, it is possible to more effectively prevent contact of adjacent ones of the plates 9.

When the connection part main body 85 protrudes into the multiple cutouts 23, the connection part main body 85 is hooked on the multiple locking parts 21, and the lock member 29 is locked to the multiple locking parts 21. Namely, the connection part main body 85 functions as a hook part that is inserted in each of the cutouts 23 provided in the multiple plates 9 and is hooked on each of the locking parts 21. Also, the arm connection part 77 functions as a locked part that is locked to the locking part 21.

In this way, since the connection part main body 85 protrudes into multiple cutouts 23, the connector 1 can be locked to the fuel cell 3 more firmly compared to the case where the lock member 29 is locked by the connection part main body 85 protruding into a single cutout 23. Also, since locking is made by the connection part main body 85 protruding into the cutouts 23, even if shifted in the stacking direction of the plates 9, the lock member 29 can be locked to the locking parts 21 and the connector 1 can be locked to the fuel cell 3.

In the present embodiment, as shown in FIG. 1, the left and right edges of the upper surfaces of the housing side portions 39 are respectively provided with the protection walls 39A that protrude upward. Therefore, the levers 31 are surrounded by the protection walls 39A from the left and right sides, and insertion of the levers 31 not intended by the user due to collision of an object or the like can be prevented.

In the foregoing, the present invention has been described based on specific embodiments, but these embodiments are mere examples and the present invention is not limited by these embodiments. Not all of the components of the connector 1 shown in the above embodiment are necessarily indispensable, and at least a person of ordinary skill in the art can selectively adopt them as appropriate without departing from the scope of the present invention.

In the above embodiment, the connector 1 is provided with five mechanisms; the holding mechanism 99, the first cam mechanism 101, the restriction mechanism 103, the detachment preventing mechanism 104, and the second cam mechanism 109, but the connector 1 may be provided only the first cam mechanism 101 and the restriction mechanism 103. In the above embodiment, each of the first cam mechanism 101, the restriction mechanism 103, the detachment preventing mechanism 104, and the second cam mechanism 109 is a mere example, and they may be realized by other configurations having similar effects.

In the above embodiment, it was described that when the connection part main body 85 protrudes from the housing 25, the lock member 29 is in the protruding position, but it is only required that the connection part main body 85 is engageable with the cutouts 23 when in the protruding position. For example, any arrangement may be adopted so long as, when the lock member 29 is in the protruding position, at least a part of the connection part main body 85 is positioned outside a bottom surface 45A (see FIG. 9(E)) and protrudes into the cutouts 23 at least in a part so that the lock member 29 is locked to the plates 9.

In the above embodiment, the pull-out part 107 is provided at a tip portion of the Y-shaped part 97, but the present invention is not limited by the position of the pull-out part 107. Also, in the above embodiment, description was made by exemplarily showing the configuration in which the lever 31 was pulled out by using the tool 105, but in the present invention, the tool 105 is not indispensable and the present invention is not limited by presence or absence of the tool 105 for pulling out the lever 31.

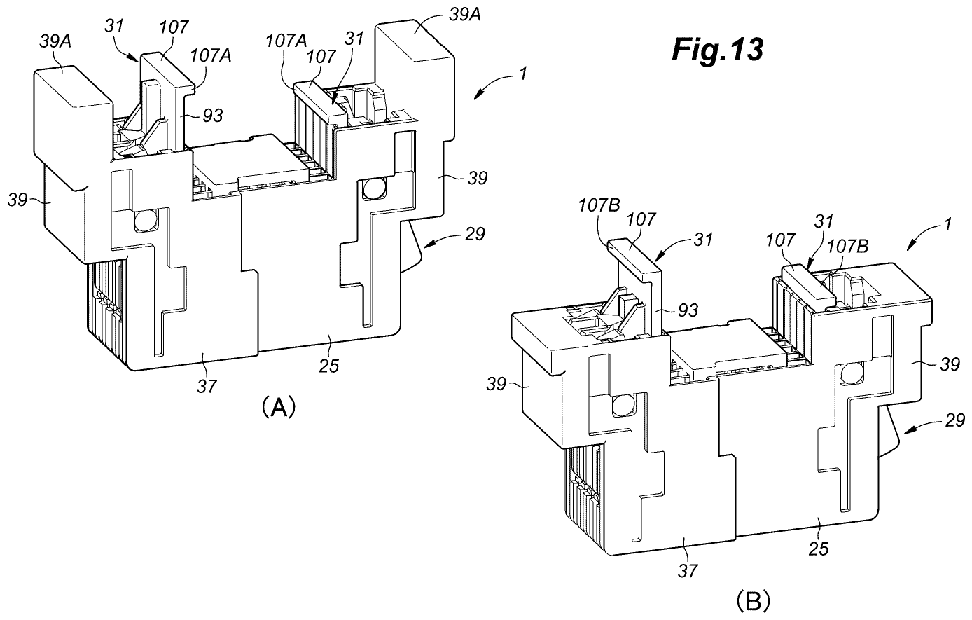

FIG. 13(A) and FIG. 13(B) each show a modification of the pull-out part 107. As shown in FIG. 13(A) and 13(B), the pull-out part 107 may be provided at the upper edge, namely, at the rear edge with respect to the insertion direction, of the lever main body 93, for example.

The pull-out part 107 may be configured by a wall body protruding in a direction perpendicular to the insertion direction at the rear edge of the lever main body 93 with respect to the insertion direction. For example, as shown in FIG. 13(A) (the first modification of the connector 1), the pull-out part 107 may be configured as a protruding wall 107A that protrudes toward the side of the wires 49 (the terminal members 27) at the upper edge of the lever main body 93. Also, as shown in FIG. 13(B) (the second modification of the connector 1), the pull-out part 107 may be configured as a protruding wall 107B that protrudes toward the side opposite from the wires 49 (the terminal member 27) at the upper edge of the lever main body 93, for example. With such a configuration, the user can directly and easily pinch the rear end portion of the lever main body 93 with respect to the insertion direction, and thus, the user can insert/remove the lever 31 into/from the housing 25 without using the tool 105.

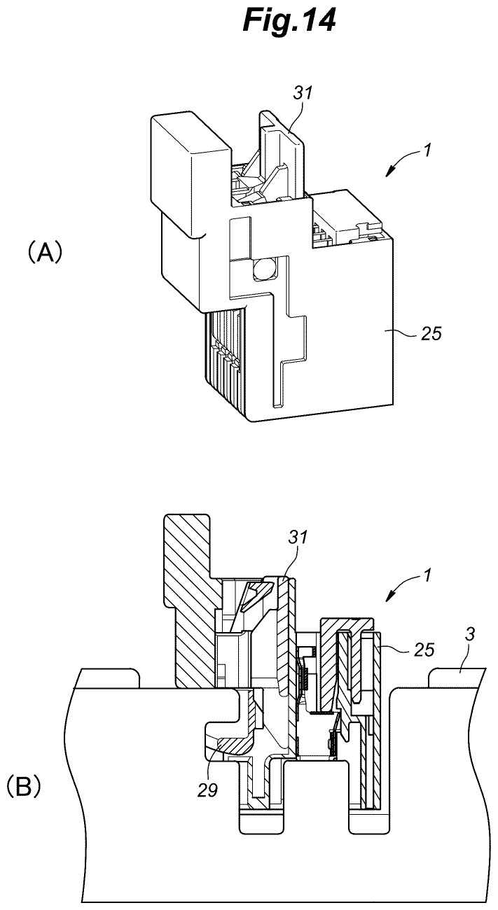

Further, in the above embodiment, an example in which the lock members 29 are provided at both left and right ends of the connector 1, respectively, but in the present invention, the positions of the lock members 29 may not be at the left and right ends of the connector 1, and the number of the lock members 29 is not limited to two. For example, the lever 31 may be provided on only one of the left and right sides of the connector 1 as shown in FIG. 14(A) (the third modification of the connector 1), and the lock member 29 also may be provided on only one of the left and right sides of the connector 1 as shown in FIG. 14(B). It is only required that the connector 1 is provided with at least one lock member 29, and it is only required that at least one lever 31 for causing the lock member 29 to protrude and retreat is provided.

Also, in the above embodiment, the connector 1 is provided with two protection walls 39A, but the protection walls 39A are not indispensable, and an arrangement in which the connector 1 is provided with one protection wall 39A may be adopted.

### LIST OF REFERENCE NUMERALS

1: connector
3: fuel cell
5: cell
7: membrane-electrode assembly
7A: air electrode
7B: fuel electrode
7C: polymer electrolyte membrane
9: plate
11: receiving recess
13: assembly recess
15: receiving groove
17: receiving space
19: terminal part
21: locking part
23: cutout
25: housing
27: terminal member
29: lock member
31: lever
37: housing main body
39: housing side portions
39A: protection wall
41: terminal holes
43: separation wall
45: separation groove
45A: bottom surface
47: retainer
49: wiring
53: crimp part
55: contact part
61: lock member receiving part
61A: detachment preventing protrusion
63: inner wall
65: outer wall
65A: protruding part
67: front wall
69: rear wall
71: lower wall
75: arm part
77: arm connection part (locked part)
79: shaft part
81: bearing part
83: through hole
85: connection part main body (hook part)
85A: vertical wall
85B: horizontal wall
87: insertion wall
87A: arm receiving groove
89: ridge
89A: first arm inclined surface
91: protrusion
91A: lock retaining surface
91B: second arm inclined surface
93: lever main body
95: rail part
95A: lever retaining surface
95B: first rail inclined surface
95C: second rail inclined surface
97: Y-shaped part
97A: plate part
97B: locking claw
97C: detachment preventing claw
99 holding mechanism
101: first cam mechanism
103: restriction mechanism
104: detachment preventing mechanism
105: tool
107: pull-out part
107A: protruding wall
107B: protruding wall
109: second cam mechanism
X: axis

1. A connector that can be attached to and detached from a fuel cell,
wherein the fuel cell is provided with multiple plates arranged at intervals in a predetermined stacking direction and each having a receiving recess,
each of the receiving recesses of the plates is provided with a locking part, and
the connector comprises:
a housing that can be inserted into the receiving recesses of the multiple plates;
terminal members held by the housing and electrically connected to the plates when the housing is inserted into the receiving recesses;
a lever that can be inserted into the housing; and
a lock member which, with a pressing force due to insertion of the lever, rotates about an axis extending in the stacking direction and engages with the locking part.

2. The connector according to claim 1, wherein the lock member is provided with a locked part that can be locked to the locking part, and
due to insertion of the lever into the housing, the lock member is displaced from a retracted position in which the locked part is retracted into an inside of the housing to a protruding position in which the locked part protrudes to an outside of the housing.

3. The connector according to claim 2, wherein the locking part includes a cutout provided in the plate, and
the locked part includes a hook part configured to be inserted into each of the cutouts provided in the multiple plates that are adjacent to each other and to be hooked on the plates and at least one insertion wall configured to be inserted between the plates.

4. The connector according to claim 3, wherein, the insertion wall is inserted between each pair of adjacent plates of the multiple plates on which the hook part is hooked.

5. The connector according to claim 1, wherein the lock member is provided with a pair of shaft parts extending along a direction of the axis,
the housing is provided with bearing parts for rotatably receiving the shaft parts of the lock member and includes a lock member receiving part for receiving the lock member, and
the lock member rotates due to insertion of the lever into the lock member receiving part.

6. The connector according to claim 1, wherein an insertion direction of the lever into the housing is the same as an insertion direction into the receiving recess.

7. The connector according to claim 1, wherein the lever and the lock member are provided with a first cam mechanism for converting a movement of the lever in an insertion direction to a rotation of the lock member.

8. The connector according to claim 2, wherein the lever and the housing are provided with a restriction mechanism for restricting a rotation of the lock member by restricting a movement of the lever in a direction opposite to an insertion direction when the lock member comes to the protruding position.

9. The connector according to claim 8, wherein the lever includes a pull-out part for pulling out from the housing in the direction opposite to the insertion direction against restriction by the restriction mechanism, and
a second cam mechanism for rotating the lock member from the protruding position to the retracted position according to the movement of the lever in the direction opposite to the insertion direction is provided between the lever and the lock member.

10. The connector according to claim 1, wherein the lock member is provided in each of both end portions in a direction perpendicular to an insertion direction of the housing and perpendicular to the stacking direction.
